(19) United States
(12) Patent Application Publication
(10) Pub. No.: US 2011/0272453 A1
(43) Pub. Date: Nov. 10, 2011

(54) METHOD AND DEVICE FOR INTRODUCING SOLDER ONTO A WORKPIECE

(75) Inventors: Hilmar Von Campe, Bad Homburg (DE); Stefan Meyer, Ronneburg (DE); Stefan Huber, Rechtmehring (DE)

(73) Assignee: Schott Solar AG

(21) Appl. No.: 13/101,602

(22) Filed: May 5, 2011

(30) Foreign Application Priority Data
May 5, 2010 (DE) 10 2010 016 814.9

(51) Int. Cl. B23K 1/20; B23K 3/04; B23K 3/08; B23K 31/02; B23K 3/06

(52) U.S. Cl. 228/205; 228/256; 228/33; 228/18

(57) ABSTRACT

A method and a device for introducing solder onto a solar cell is provided. The method and device employ a solder wire introduced in the molten state onto the solar cell under the action of ultrasonic vibrations applied by a sonotrode. Solder is introduced very precisely onto the solar cell, without subjecting the solar cell to undesirably high temperatures, by introducing the solder wire into a gap running between a heating device and the sonotrode, which applies ultrasonic vibrations and melts and flows through the gap onto the solar cell.

### CROSS REFERENCE TO RELATED APPLICATIONS

This application claims benefit under 35 U.S.C. §119(a) of German Patent Application No. 10 2010 016 814.9, filed May 5, 2010, the entire contents of which are incorporated herein by reference.

### BACKGROUND OF THE INVENTION

1. Field of the Invention

The invention relates to a method for introducing solder onto a workpiece, preferably onto a semiconductor device such as a solar cell, wherein solder is applied in the molten state onto the workpiece under ultrasonic action with the use of a solder wire. Further, the invention relates to a device for introducing solder onto a workpiece, in particular onto a semiconductor device such as a solar cell, comprising a solder-wire introduction means, a heating means for the solder wire, an ultrasonic sonotrode as well as a transport means for the transport of the workpiece relative to both the heating means as well as the ultrasonic sonotrode, wherein the solder wire is melted in a heating zone associated with the heating means.

2. Description of Related Art

A method for introducing a connecting conductor onto a solar cell, in which a solder is applied onto the solar cell by means of ultrasonic soldering, is known from WO-A-2008/014900 (DE-A-10 2006 035 626). In this case, the solder in the form of a solder wire or solder preforms is soldered on at the soldering temperature by means of an ultrasonic sonotrode.

The soldering of solder onto solar cells, in particular by means of ultrasound has the advantage that a fluxing agent does not need to be used, whereby if it had to be used, the danger of damage to the solar cell would increase. Due to the ultrasonic action, oxide layers present on the solar cells are broken up, in order to assure a mechanically solid and electrically well-conducting joint between the solder and the corresponding metal layer of the solar cell. This is particular of advantage when the metal layer involves an aluminum layer such as a back-surface contact composed of aluminum.

Corresponding ultrasound soldering methods are also taken from, e.g., U.S. Pat. No. 6,357,649 or the reference Mardesich et al.: “A Low-Cost Photovoltaic Cell Process Based on Thick Film Techniques”; 14th IEEE PV, Sp. Conf. Proc., 1980, pp. 943-947.

### BRIEF SUMMARY OF THE INVENTION

The problem of the present invention is to enhance a method and a device of the type named initially, so that the solder is introduced very precisely onto the workpiece without subjecting the workpiece to undesirably high temperatures.

In order to solve the problem, it is essentially proposed according to the method that the solder wire is introduced in a gap running between a heating means and a sonotrode producing ultrasonic vibrations, is melted in the gap, and flows through the gap onto the workpiece.

Unlike the prior art, the solder material is not guided through a heating means and then delivered through an opening in order to solder the workpiece via ultrasonic action, which can also be designated “soldering on”. Rather, the solder wire is introduced into a free gap on the side, whereby the width of the gap is predetermined by the distance between heating means and sonotrode. Here, the gap between the sonotrode and the heating means is preferably designed in such a way that it has a width B that is preferably approximately ½D≦B≦D with D=the diameter of the solder wire.

According to the invention, not only is the heating means heated to a temperature above the melting point of the solder wire, but the sonotrode is also, the temperature adjustment being made independently in each case.

Since the gap is bounded by the sonotrode excited to longitudinal vibration, despite the high surface tension that the molten solder possesses, the solder is pulled through the gap. In this respect, the gap exercises roughly a capillary effect.

Due to the provision provided in this respect, there particularly also results the advantage that conventional solder materials can be successfully used as the basis for the soldering of workpieces, in particular solar cells, materials such as those based on tin-zinc, tin-silver, or even of pure tin.

It is provided in an enhancement that operation is conducted at a low sonotrode frequency, preferably in the range between 10 kHz and 40 kHz, in order to avoid a shunting of the surface layer, such as an SiNₓ layer, running on the top surface of a solar cell. Further, it is particularly provided that the lengthwise axis of the sonotrode encloses an angle of <90° relative to the normal line proceeding from the surface of the workpiece such as a solar cell, so that a completely horizontal alignment, thus a horizontal coupling is possible.

Further, there exists the possibility of allowing the sonotrode vibration to deviate from the resonance frequency in a targeted manner. This can be carried out by off-tuning the sonotrode or by employing a sonotrode length that deviates from a whole-number λ/2, λ being the amplitude of the ultrasonic vibration.

The rate of application of the solder should lie in the range between 0.1 millimeter per second (mm/sec) and 200 mm/sec, in particular between 20 mm/sec and 80 mm/sec.

In addition, there is the possibility of introducing solder strips that exercise the function of busbars, which are commonly applied onto solar cells, by means of the method according to the invention. Thus, there is the possibility of introducing, e.g., two or more busbars, preferably of tin, onto the front side of a solar cell. The solder tracks exercising the function of busbars should thus have widths between 0.5 millimeters (mm) and 15 mm, preferably in the range of 2 mm.

In order to achieve a sufficient process stability, it is further provided that the ultrasound system used is continuously active, thus the sonotrode constantly vibrates, in order to avoid deviations in resonance that may occur in actuating the ultrasound system. A continuous vibrational excitation additionally has the advantage that solder-caused wetting properties are stabilized in the heating zone between the heating means and the sonotrode.

In addition, it is particularly advantageous that an encrustation can be eliminated without problem in the region where the molten solder is introduced by cleaning the gap by providing a blow-off pulse after soldering one workpiece or a predetermined number of workpieces. This cleaning is then carried out when the device comprising the heating means and the sonotrode is raised, so as to position a new workpiece in the region of the sonotrode.

The blowing off can be particularly carried out by employing a gas such as N₂, air, argon or other suitable inert gases. However, a rinsing with a liquid may also be carried out.

Alternatively or in addition, a cleaning means can be provided, in order to free the gap between the sonotrode and the heating means from e.g., solder-caused encrustrations, for example, by employing rotating brushes or other suitable elements. There is also the possibility of setting up a suction means in order to remove contaminants.

In another embodiment of the invention, a block-shaped unit having a high heating capacity is used as the heating means, which assures that a desired, uniform temperature prevails in the region of the gap. In this case, the block-shaped or cuboid-shaped heating unit can be aligned relative to the sonotrode in such a way that the longitudinal axis of the heating unit encloses an acute angle of up to 20°, preferably in the range of 0° to 5°, relative to the surface of the workpiece, proceeding from the end near the sonotrode. In this way, it is assured that an undesired heating of the workpiece is absent, since the bottom of the heating unit is inclined relative to the surface of the workpiece, in order to achieve a sufficient distance.

The gap is preferably bounded by a heating-unit projection that is shaped like a cylinder segment, wherein the gap may have the same crosswise dimension over its height—crosswise to the direction of application of the solder—and in the direction of the workpiece may expand conically, thus in the direction of application of the solder. A constant width over half of the gap is likewise possible.

A device of the type named initially is characterized in that the heating zone comprises a gap that is bounded by the heating means and the ultrasonic sonotrode, the gap being the introduction for the solder to the workpiece. It is particularly provided that the gap between the sonotrode and the heating means preferably has a width B with ½D≦B≦D, wherein D=the diameter of the solder wire.

The gap may have a constant width over its height. There is also the possibility, however, that the gap can be conically expanded in the direction of the workpiece.

The heating means in particular involves a cuboid-shaped unit which can be equipped with heating cartridges and which has a sonotrode-side projection that particularly possesses a cylindrical as well as a semi-cylindrical geometry.

In addition, the block-shaped or cuboid-shaped heating unit is preferably aligned relative to the workpiece such that, proceeding from the sonotrode, the bottom of the heating means relative to the workpiece encloses an acute angle, which can amount to approximately 20°. Preferably, the angle should lie between 0° and 5°. In this way, there is a distancing between the heating means and the workpiece with the consequence that the latter is not heated in an undesired manner.

The sonotrode, which also is heated to a temperature above the melting point of the solder material, is additionally surrounded by a thermally insulating tube, such as a ceramic tube, above the heating means.

In addition, a cleaning means is provided, by means of which a blow-off pulse is provided for cleaning the heating zone, thus the gap region. Liquid or gas such as N₂, air, argon or another inert gas can be utilized as the cleaning medium.

Alternatively or additionally, there is the possibility of assigning a cleaning means to the sonotrode and to the heating means in order to clean the gap or the heating zone. Thus, solder-caused encrustations between the heating means or the heating unit and the sonotrode can be removed without problem.

Solder-caused contaminations may also be removed by means of a suction device.

Other details, advantages and features of the invention result not only from the specific embodiments described herein, but also from the features to be derived therefrom—taken alone and/or in combination—but also from the following description of a preferred example of embodiment to be taken from the drawing.

### BRIEF DESCRIPTION OF THE SEVERAL VIEWS OF THE DRAWINGS

FIG. 1 shows a section of a device for introducing a solder material onto a workpiece.

FIG. 2 shows the section of the device according to FIG. 1 rotated by 90°.

FIG. 3 shows the section of the device according to FIGS. 1 and 2 in a bottom view.

FIG. 4 shows an excerpt from FIG. 3 in an enlarged representation.

FIG. 5 shows representations of the principle in question with solder material of a wetted and a non-wetted gap.

### DETAILED DESCRIPTION OF THE INVENTION

A section or details of a device by means of which a preferably strip-shaped solder strip is introduced onto a workpiece 10 can be taken from the figures. Workpiece 10 particularly involves a semiconductor device such as a solar cell, in order to solder electrical contacts, for example, onto it after introducing the solder material. In this case, cell connectors may be involved.

The solder material can be introduced in such a way that solder strips are formed, which exercise the function of busbars that are introduced onto the solar cell and are, in particular, connected to current collectors (grid fingers).

In order to introduce the solder onto workpiece 10, solder wire 12 is introduced into a heating zone 14 by a solder-wire introduction means (not shown), the heating zone running between a heating means 16 and a sonotrode 18 of an ultrasound device.

In the figures, sonotrode 18, which has a rod geometry, is surrounded by a ceramic tube 20 having a heating coil, above heating means 16, in order to heat the sonotrode to a temperature above the melting point of the solder material. Sonotrode 18 further proceeds in the known way from an ultrasonic transducer 22, by means of which sonotrode 18 is excited to ultrasonic vibrations in the range between 10 kHz and 80 kHz, particularly between 10 kHz and 40 kHz, just to name numbers by way of example.

In the example of embodiment, heating means 16 involves a cuboid or block-type heating unit 17, which is equipped with heating cartridges. Thus, heating unit 17 has a high heat capacity in order to assure the desired constant temperatures in the region of heating zone 14.

Solder wire 12 is introduced into heating zone 14, and, in fact, is introduced obliquely from the side in the example of embodiment, as is illustrated in principle by comparing the figures. However, the teaching according to the invention will not be limited hereby.

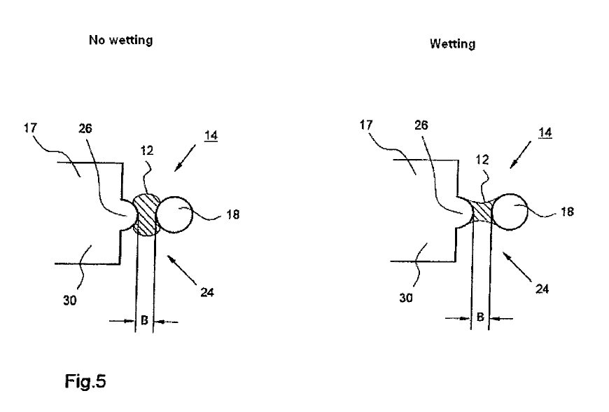

According to the invention, heating zone 14 has a gap 24, which is bounded on one side by sonotrode 18 and on the other side by a preferably semicylindrically-shaped projection 26 of heating means 16 or of heating unit 17, as results from FIGS. 3 and 4. Of course, it is not absolutely necessary that the heating unit 17 has a corresponding projection. Rather, on the sonotrode side, the heating unit 17 may have a flat surface, which likewise bounds a corresponding gap.

Preferably, however, projection 26, which may also possess a geometry having a circular section that differs, however, from that derived from the drawing, extends from the surface of heating unit 17 facing sonotrode 18.

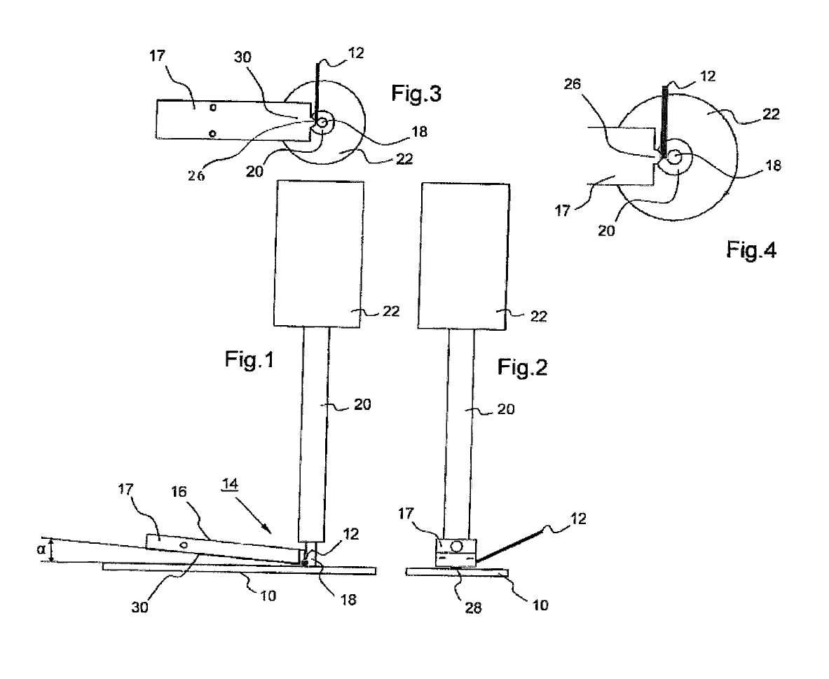

As is illustrated in FIG. 4, the gap width B, thus the clearance between sonotrode 18 and projection 26 is selected in such a way that it preferably lies between ½D and D with D=diameter of the solder wire. The width B extends in the direction of application of solder 10 onto the workpiece, thus in the plane of the drawing in FIG. 1 and parallel to the segment of workpiece 10 that is shown. The width B may be constant or may expand conically in the direction of the workpiece.

Both heating unit 17 as well as sonotrode 18 are adjusted to a temperature that lies above the melting point of solder wire 12. Preferably, solder material is used which melts in the range between 100 degrees Celsius (° C.) and 350° C., although the temperature range may lie between 80° C. and 600° C. The temperature adjustment of heating unit 17 is thus made in the region of its projection 26, independently of the adjustment of the temperature of sonotrode 18.

According to the invention, solder wire 12 is introduced into gap 24 in heating zone 14. The solder wire melts in this way. Despite the high surface tension, a wetting of the boundary of gap 24 is produced (see the representation on the right in FIG. 5) due to the sonotrode 18 excited to ultrasonic vibration, with the consequence that the molten solder flows through gap 24 onto the surface of workpiece 10 and then the solder introduced onto workpiece 10 is loaded with ultrasound [vibration] via the flat front surface 28 of sonotrode 18, this surface facing workpiece 10, in order to assure the soldering of workpiece 10. The vibration antinode of the excited sonotrode 18 runs in the region of the front surface 28.

The molten solder is shown for sonotrode 18 that is not placed in vibration in the representation on the left in FIG. 5.

As results from FIGS. 1 and 2, the cuboid-shaped or block-type heating unit 17 is aligned to the workpiece surface by its bottom 30 in such a way that, proceeding from sonotrode 18, an acute angle α results, which should lie between 0° and 20°, in particular between 0° and 5°. In this way, it is additionally assured that workpiece 10 is not heated in an undesired manner via heating unit 17.

The gap 24 may have a constant width over its height. There is also the possibility, however, that the gap is increased in the direction of workpiece 10, in particular, if the region of gap 24, which is bounded by heating unit 17, extends perpendicular to bottom 30 of heating unit 17.

In addition, it is provided according to the invention that with the use of a cleaning means (not shown), after removing the ultrasound device with heating means 16, a blow-off pulse is delivered for cleaning the gap region. In this case, a gas or a liquid may be used, which loads the gap region in pulse-like manner, so that solder-caused encrustations are removed.

Alternatively or in addition, a mechanical cleaning means can be provided, in order to remove solder-caused encrustations. In this case, these involve rotating brushes or other equally acting elements that make possible a removal of encrustations.

Further, a suction device may be provided in order to be able to collect or suction off solder-caused contaminations.

In order to achieve process stability, the sonotrode may remain continuously excited, even when a solder wire is not introduced. In this way, it is assured that resonance deviations will be avoided. Also, solder-caused wetting properties are stabilized in the gap.

The rate of application of the solder onto workpiece 10 should lie in the range between 2 mm and 200 mm/sec, preferably between 20 mm and 80 mm/sec.

Although the longitudinal direction of the sonotrode is aligned along the normal line proceeding from workpiece 10 in the example of embodiment, other angles are also possible. In particular, an oblique coupling of the ultrasound is possible. This means that the longitudinal axis of sonotrode 18 relative to the normal line proceeding from workpiece 10 encloses an angle of >0°. In this case, an alignment parallel to the surface of workpiece 10 may result optionally. The sonotrode tip or the associated surface of heating unit 17 must be designed correspondingly, in order to make available the necessary gap for the solder wire.

The invention also includes the circumstance when a targeted deviation of the resonance frequency is provided, e.g., by off-tuning sonotrode 18 or by employing a sonotrode 18 of a length that deviates from a whole-number λ/2 with λ=amplitude.

In the region of the gap, sonotrode 18 should have a cylindrical geometry with a diameter that lies between 0.5 mm and 4 mm, preferably between 1 mm and 2 mm.

What is claimed is:

1. A method for introducing solder onto a workpiece, comprising:
introducing a solder wire in a molten state onto the workpiece under the action of ultrasonic vibrations applied by a sonotrode, wherein the solder wire is introduced into a gap running between a heating device and the sonotrode that applies ultrasonic vibrations and is melted and flows through the gap onto the workpiece.

2. The method according to claim 1, wherein the gap between the sonotrode and heating device is adjusted to a width B that has a dimension that is between greater than or equal to ½ diameter of the solder wire to less than or equal to the diameter of the solder wire.

3. The method according to claim 1, further comprising heating the sonotrode and the heating device to a temperature above a melting point of the solder wire.

4. The method according to claim 3, further comprising adjusting a temperature of the heating device independently from a temperature of the sonotrode.

5. The method according to claim 1, wherein the heating device comprises a block-shaped or cuboid-shaped heating unit having a projection bounding the gap, the projection having, on a side proximate the sonotrode, a cylindrical-section geometry.

6. The method according to claim 5, further comprising aligning the heating device relative to the sonotrode such that that gap has an equal width over its height or expands in the direction of the workpiece.

7. The method according to claim 1, further comprising cleaning, after applying the solder wire to the workpiece and prior to applying the solder wire to another workpiece, the gap by a pulse-type loading of a liquid or a gas.

8. The method according to claim 1, wherein the solder wire comprises a material selected from the group consisting of pure tin, material based on Sn—Zn, and material based on Sn—Ag.

9. The method according to claim 1, wherein the sonotrode encloses an angle α with 0°<α≦90° by its longitudinal axis relative to a normal line proceeding from a surface of the workpiece.

10. The method according to claim 1, further comprising introducing the solder wire at a rate between 0.1 mm/s to 200 mm/s.

11. The method according to claim 1, wherein the workpiece comprises a solar cell, and wherein the introducing step comprises applying the solder wire as a busbar on the solar cell to a width of between 0.5 mm and 15 mm.

12. The method according to claim 1, further comprising maintaining the sonotrode excited to vibration with continuous introduction of the solder wire.

13. The method according to claim 1, further comprising placing the sonotrode in vibration with a frequency deviating from a resonance frequency of the sonotrade.

14. A device for introducing a solder onto a workpiece, comprising:
a solder-wire introduction device,
a heating device,
an ultrasonic sonotrode configured to apply ultrasonic energy, and
a transport device for transport of the workpiece relative to both the heating device and the ultrasonic sonotrode,
wherein the solder wire is melted in a heating zone comprising a gap bounded by the sonotrode and the heating device.

15. The device according to claim 14, wherein the heating device is a block-shaped or cuboid-shaped heating unit having a projection bounding the gap on a side of the sonotrode, the projection having a cylindrical-section geometry.

16. The device according to claim 15, wherein the heating unit has a bottom relative to a surface of workpiece, and wherein the sonotrode encloses an acute angle α between 0°<α≦20°.

17. The device according to claim 14, wherein the gap has a constant width B over its height or is enlarged in a direction of the workpiece.

18. The device according to claim 14, further comprising a cleaning device, by which a cleaning medium is introduced into the gap in a pulse-like manner.

19. The device according to claim 14, further comprising a cleaning device configured to mechanically clean the gap.

20. The device according to claim 14, further comprising a suction device for suctioning solder-caused contaminations.
